(19) United States
(12) Patent Application Publication
(10) Pub. No.: US 2021/0362594 A1
(43) Pub. Date: Nov. 25, 2021

(54) CAR DRIVER ALCOHOL LEVEL AND SLEEPING STATUS DETECTION AND NOTIFICATION SYSTEM

(71) Applicants: R. MADANA MOHANA, HYDERABAD (IN); YUKTESH CHINTAMADAKA, HYDERABAD (IN); CHANDIKA MOHAN BABU, HYDERABAD (IN); K.S. NIRAJA, HYDERABAD (IN); K. THIRUPAL REDDY, HYDERABAD (IN); M. CHURCHILL DASS PRINCE, CHENNAI (IN); N T KISHORE KUMAR, CHENNAI (IN); VIANALA SUNITHA, HYDERABAD (IN); Veerendra Chitrala, Secunderabad (IN); P. Kiranmai, Warangal (IN); Mritunjay Kumar Vishwakarma, Ghaziabad (IN); Angajala Kishore Kumar, Hyderabad (IN); Raman Dugyala, Shamshabad (IN)

(72) Inventors: R. MADANA MOHANA, HYDERABAD (IN); YUKTESH CHINTAMADAKA, HYDERABAD (IN); CHANDIKA MOHAN BABU, HYDERABAD (IN); K.S. NIRAJA, HYDERABAD (IN); K. THIRUPAL REDDY, HYDERABAD (IN); M. CHURCHILL DASS PRINCE, CHENNAI (IN); N T KISHORE KUMAR, CHENNAI (IN); VIANALA SUNITHA, HYDERABAD (IN); Veerendra Chitrala, Secunderabad (IN); P. Kiranmai, Warangal (IN); Mritunjay Kumar Vishwakarma, Ghaziabad (IN); Angajala Kishore Kumar, Hyderabad (IN); Raman Dugyala, Shamshabad (IN)

(21) Appl. No.: 17/195,992

(22) Filed: Mar. 9, 2021

(51) Int. Cl. B60K 28/06; B60Q 9/00; B60R 11/04; G08B 7/06; G08B 21/18; G10L 13/047; G10L 15/22; G10L 15/18

(52) U.S. Cl. CPC B60K 28/066; B60Q 9/00; B60R 11/04; G08B 7/06; B60R 2011/001; G10L 13/047; G10L 15/22; G10L 15/18; G08B 21/182

(57) ABSTRACT

The present invention “car driver alcohol level and sleeping status detection and notification system using machine learning programming and IOT-based technology “is a vehicle driver sleepiness monitor, configured as a auto-contained Unit for dashboard unit. The invention is also providing for individual driver interrogation and notification response integrated with defined and fixed unit sensory inputs on vehicle condition and driver control action and translates these inputs into weighing factors to adjust a previous history and biological activity circadian rhythm reference Unit. The invention is also including an in turn to provide a vibration, water spray and audio-visual sleepiness warning alert and an automatic dialog system capable of keeping a drive awake while driving during a long trip or one that extends into the late evening. The invented system also warns the driver or changes the topic of conversation if the system determines that the driver is about to fall asleep and the system may also detect whether a driver is effected by alcohol or drugs or any other activity. The invented technology also includes a for drowsiness detection and accident prevention using Raspberry Pi. This system is an auto rune a real-time system which captures high resolution image continuously and measures the state of the eye movement according to the specified algorithm and gives a warning if required.

### FIELD OF THE INVENTION

Our invention is related to a car driver alcohol level and sleeping status detection and notification system using machine learning programming and IOT-based technology and in the field of computer science and engineering.

### BACKGROUND OF THE INVENTION

There are huge worries regarding the road accident it can happen anytime anyplace; it is an enormous problem in India. According to the Association for Safe International Road Travel, about 1.24 million die and 50 million are injured on the roads of the world every year. Artistically, they are treated the second leading source of death. Nowadays, most of the road disaster basis on drink-driving. This is a severe problem which possibly would appear as one of the most essential threats in the future. The alcohol level in breath is measured by the traffic police but this does not break the chain of drinking and driving. Police check the alcohol levels but they cannot stop drivers to drink. Another crucial aspect is sleeping on the wheel. A sleepy driver who falls in sleep and fails to handle a car, it is not possible to catch the situation and handle the position and consequences of an accident. It is important to prevent these types of accidents and detects the drowsiness of the driver. It is an important challenge to solve this type of problem.

As such, the invention is particularly, but not exclusively, concerned with the (automated) recognition of sleepiness and performance-impaired fatigue in drivers of motor vehicles upon the public highway. Professional drivers of, say, long-haul freight lorries or public transport coaches are especially vulnerable to fatigue, loss of attention and driving impairment. With this in mind, their working and active driving hours are already carefully monitored to ensure they are within prescribed limits. Road accidents, some with no apparent external cause, have been attributed to driver fatigue. Studies, including those by the Applicants themselves, (see the list of references at the end of this disclosure), into sleep-related vehicle accidents have concluded that such accidents are largely dependent on the time of day. Age may also be a factor—with young adults more likely to have accidents in the early morning, whereas older adults may be more vulnerable in the early afternoon.

To avoid accidents, it is crucial to develop a system. There are preventive methods that need to be developed. It is mandatory to alert the driver to stop road accidents. It is also very important to track car if driver detected drunk and send message and location to family member. Car tacking is also useful in case of theft. For theft prevention, car tracking systems are famous among the public as a betterment deice. The important advantage of vehicle tracking systems is the safety function by monitoring the location of the car which can be used as a conservation approach for the vehicles that are stolen. A tracking system is also useful in case of theft to send coordinates to family members, police centers, etc. We all know accidents occur anytime. Many people among us lose their life in road accidents and while driving if accident detects then it is necessary to alert driver's family members. This system aims to prevent accidents due to drink-driving and drowsiness of driver. If driver is drunk, then system turns off the ignition and alert send to the family members. Family members can track vehicle through web site. While driving if driver feels sleepy then system alerts driver through buzzer and vibration. Drowsiness detection technique is possible through image processing. In addition, system will continuously monitor accidents and if accident is detecting then it will send alert to family members through GPRS. Vehicle tracking is important feature of project. It is used in case of theft and other critical condition.

This invention relates to human sleepiness, drowsiness or (lack of) alertness detection and monitoring, to provide a warning indication in relation to the capacity or fitness to drive or operate (moving) machinery. Although its rationale is not fully understood, it is generally agreed that sleep is a powerful and vital, biological need, which—if ignored—can be more incapacitating than realised, either by a sleepy individual subject, or by those tasking the subject.

Drivers may not recollect having fallen asleep, but may be aware of a precursory sleepy state, as normal sleep does not occur spontaneously without warning. The present invention addresses sleepiness monitoring, to engender awareness of a state of sleepiness, in turn to prompt safe countermeasures, such as stopping driving and having a nap. Accidents have also been found to be most frequent on monotonous roads, such as motorways and other main roads. Indeed, as many as 20-25% of motorway accidents seem to be as a result of drivers falling asleep at the wheel. Although certain studies concluded that it is almost impossible to fall asleep while driving without any warning whatsoever, drivers frequently persevere with their driving when they are sleepy and should stop. Various driver monitoring devices, such as eyelid movement detectors, have been proposed to assess fatigue, but the underlying principles are not well-founded or properly understood.

Sleepiness in the context of driving is problematic, because the behavioral and psychological processes which accompany falling asleep at the wheel may not typify the characteristics of sleep onset commonly reported under test conditions and simulations by sleep laboratories. Driving will tend to make a driver put considerable effort into remaining awake, and in doing so, the driver will exhibit different durations and sequences of psychological and behavioural events that precede sleep onset. As underlying sleepiness may be masked by this prefacing compensatory effort, the criteria for determining whether a subject is falling asleep may be unclear. Indeed, the Applicants have determined by practical investigation that parameters usually accepted to indicate falling asleep are actually not reliable as an index of sleepiness if the subject is driving.

For example, although in general eye blink rate has a tendency to rise with increasing sleepiness, this rate of change is confounded by the demand, variety and so stimulus content or level of a task undertaken (eg driving), there being a negative correlation between blink rate and task difficulty. In an attempt to prevent sleep-related vehicle accidents, it is also known passively to monitor driver working times through chronological activity logs, such as tachographs. However, these provide no active warning indication. More generally, it is also known to monitor a whole range of machine and human factors for vehicle engineering development purposes, some merely for historic data accumulation, and other unsatisfactory attempts at ‘real-time’ active warning. The Applicants are not aware of any practical implementation hitherto of sleepiness detection, using relevant and proven biological factors addressing inherent body condition and capacity. Studies and trials carried out by the Applicants have shown that there are clear discernible peaks of sleep-related vehicle accidents in the UK around 02.00-06.00 hours and 14.00-16.00 hours.

Similar time-of-day data for such accidents have been reported for the USA, Israel and Finland. These sleep-related vehicle accident peaks are distinct from the peak times for all road traffic accidents in the UK—which are around the main commuting times of 08.00 hours and 17.00 hours. The term ‘sleepiness’ is used herein to embrace essentially pre-sleep conditions, rather than sleep detection itself, since, once allowed to fall asleep, it may be too late to provide useful accident avoidance warning indication or correction.
1. Generally, a condition or state of sleepiness dictates
2. a lessened awareness of surroundings and events
3. a reduced capacity to react appropriately;
4. an extended reaction time.

It is known from sleep research studies that the normal human body biological or physiological activity varies with the time of day, over a 24 hour, (night-day-night) cycle—in a characteristic regular pattern, identified as the circadian rhythm, biorhythm or body clock. The human body thus has a certain predisposition to drowsiness or sleep at certain periods during the day-especially in early morning hours and midafternoon. This is exacerbated by metabolic factors, in particular consumption of alcohol, rather than necessarily food per se. The present invention is directed in general to an automatic dialog car system. More particularly, the invention is directed to an automatic dialog car system designed to prevent a driver from falling asleep during long trips or trips that extend into the evening.

A leading cause of traffic accidents is by drivers who fall asleep at the wheel. There exist various devices designed to prevent drivers from falling asleep. For example, one conventional device includes a miniature system installed in a driver's hat, to measure the slope of the driver's head. If the slope of the driver's head exceeds a predetermined threshold, a loud audible signal is generated to awaken the driver. The problem with such a prevention system is that the driver can lose control of the car several moments before his head changes positions. That is, a driver may fall asleep before his head drops beyond the threshold that triggers the audible signal. Various other methods have been tried, for example, the use of stimulation drinks (e.g., coffee and tea) and tablets for preventing drivers from sleeping during such situations. However, all such methods have not been successful. It is well known that to keep the driver awake while driving, he should talk with someone in the car (or over a car telephone). However, it is obvious that such options are not always available for those times when a driver is driving alone in the car or a car telephone is not accessible.
U.S. Pat. No. 4,297,685A *1979-05-311981-10-27Environmental Devices Corporation Apparatus and method for sleep detection
DE4400207A11993-01-061994-07-07Mitsubishi Motors Corp Vehicle driver sleep warning system with heart beat sensor
WO1995005649A11993-08-131995-02-23Vorad Safety Systems, Inc. Method and apparatus for determining driver fitness in real time
EP0713675A21994-11-161996-05-29Pioneer Electronic Corporation Driving mental condition detecting apparatus

### OBJECTIVES OF THE INVENTION

1. The objective of the invention is to a also providing for individual driver/operator interrogation and response, combined with various objective sensory inputs on vehicle condition and driver control action, and translates these inputs into weighing factors to adjust a biological activity circadian rhythm reference model.
2. The other objective of the invention is to in turn to provide an audio-visual sleepiness warning indication and an automatic dialog system capable of keeping a drive awake while driving during a long trip or one that extends into the late evening.
3. The other objective of the invention is to carries on a conversation with the driver on various topics utilizing a natural dialog car system and the system includes an automatic speech recognition module, a speech generation module which includes speech synthesis or recorded speech, and possibly dynamically combined speech synthesizer and recorded speech, and a natural language processing module.
4. The other objective of the invention is to natural dialog car system analyzes a driver's answer and the contents of the answer together with his voice patterns to determine if he is alert while driving.
5. The other objective of the invention is to warns the driver or changes the topic of conversation if the system determines that the driver is about to fall asleep and the system may also detect whether a driver is effected by alcohol or drugs.

### SUMMARY OF THE INVENTION

According to one aspect of the invention a monitor taking account of circadian and sleep parameters of an individual vehicle driver, and/or generic or universal human physiological factors, applicable to a whole class or category of drivers, is integrated with ‘real-time’ behavioural sensing, such as of road condition and driver control action, including steering and acceleration, to provide an (audio-) visual indication of sleepiness. For safety and legislative reasons, it is not envisaged that, at least in the immediate future, an alert condition would necessarily be allowed automatically to override driver control—say by progressively disabling or disengaging the vehicle accelerator. Rather, it would remain a driver's responsibility to respond constructively to an alert issued by the system—which could log the issue of such warnings for future reference in assessing compliance.

Overall system capability could include one or more of such factors as: common, if not universal, underlying patterns or sleepiness (pre-conditioning); exacerbating personal factors for a particular user—driver, such as recent sleep patterns especially, recent sleep deprivation and/or disruption; with a weighting according to other factors, such as the current time of day. Thus background circumstances, in particular a natural alertness ‘low point’—and attendant sleepiness or susceptibility to (unprompted) sleep—in the natural physiological biorhythmic or circadian cycle may pre-dispose a driver to sleepiness, exacerbated by sleep deprivation in a recent normal sleep period. If not circadian rhythm patterns themselves, at: least the ability of the body behaviour and activity to respond to the underlying pre-disposition or pre-condition, may be disturbed or frustrated by abnormal or changing shift: patterns, prefaced by inadequate acclimatization.

Thus, for example, in exercising vehicle control, aberrant driver steering behaviour, associated with degrees of driver sleepiness, could be recognised and corrected—or at: least a warning issued of the need for correction (by sleep restitution). Pragmatically, any sleepiness warning indication should be of a kind and in sufficient time to trigger corrective action. According to another aspect of the invention, a driver sleepiness, alertness or fitness condition monitor comprises a plurality of sensory inputs, variously and respectively related to, vehicle motion and steering direction, circadian or biorhythmic physiological patterns, recent driver experiences and preconditioning;

such inputs being individually weighted, according to contributory importance, and combined in a computational decision algorithm or model, to provide a warning indication of sleepiness. Some embodiments of the invention can take into account actual, or real-time, vehicle driving actions, such as use of steering and accelerator, and integrate them with inherent biological factors and current personal data, for example recent sleep pattern, age, sex, recent alcohol consumption (within the legal limit), reliant upon input by a driver being monitored.

Steering action or performance is best assessed when driving along a relatively straight road, such as a trunk, arterial road or motorway, when steering inputs of an alert driver are characterized by frequent, minor correction. In this regard, certain roads have characteristics, such as prolonged ‘straightness’ and monotonous contouring or landscaping, which are known to engender or accentuate driver sleepiness. It is envisaged that embodiments of the steering detector will also be able to recognise when a vehicle is on such (typically straighter) roads. Some means, either automatically through a steering sensor, or even from manual input by the driver, is desirable for motorway as opposed to, say, town driving conditions, where large steering movements obscure steering irregularities or inconsistencies.

Indeed, the very act of frequent steering tends to contribute to, or stimulate, wakefulness. Yet a countervailing tendency to inconsistent or erratic steering input may prevail, which when recognised can signal an underlying sleepiness tendency. In practice, having recognised the onset of journeys on roads with an enhanced sleepiness risk factor, journey times on such roads beyond a prescribed threshold-say 10 minutes-could trigger a steering action detection mode, with a comparative test against a steering characteristic algorithm, to detect sleepy-type driving, and issue a warning indication in good time for corrective action. As another vehicle control condition indicator, accelerator action, such as steadiness of depression, is differently assessed for cars than lorries, because of the different spring return action. Implementation of semi-automated controls, such as cruise-controls, with constant speed setting capabilities, could be disabled temporarily for sleepiness monitoring. In assessing driver responses to pre-programmed device interrogation, reliance is necessarily placed upon the good intentions, frankness and honesty of the individual.

A practical device would embody a visual and/or auditory display to relay warning messages and instructions to and responses from the user. Similarly, interfaces for vehicle condition sensors, such as those monitoring steering and accelerator use, would be incorporated. Furthermore, input (push-button) switches for driver responses could also be featured-conveniently adjacent the visual display. Input effort would be minimal to encourage participation, and questions would be straightforward and direct, to encourage explicit answers.

Visual display reinforcement messages could be combined with the auditory output. Ancillary factors, such as driver age and sex, could also be input. An interface with a global positioning receiver and map database could also be envisaged, so that the sleepiness indicator could register automatically roads with particular characteristics, including a poor accident record, and adjust the monitoring criteria and output warning display accordingly. The device could be, say, dashboard or steering wheel mounted, for accessibility and readability to the driver. Ambient external light conditions could be sensed by a photocell. Attention could thus be paid at night to road lighting conditions.

Vehicle driving cab temperature could have a profound effect upon sleepiness, and again could be monitored by a localised transducer at the driver station. The device could categories sleepiness to an arbitrary scale. Thus, for example, the following condition levels could be allocated:

### ALERT

### A LITTLE SLEEPY

### NOTICEABLY SLEEPY

### DIFFICULTY IN STAYING AWAKE

### FIGHTING SLEEP

### WILL FALL ASLEEP

Personal questions could include:

### QUANTITY OF SLEEP IN THE LAST 24 HOURS

### QUALITY OF THAT SLEEP IN THE LAST 24 HOURS

Road conditions could include:

### MOTORWAY

### MONOTONOUS

### TOWN

Night-time with no street lights could be given a blanket impairment rating or loading. Assumptions are initially made of no alcohol consumption whatsoever (ie legal limits disregarded). A circadian rhythm model allows a likelihood of falling asleep, or a sleep propensity, categorized between levels 1 and 4—where 4 represents very likely and 1 represents unlikely. The lowest likelihood of sleepiness occurs from mid-morning to early afternoon. Thereafter a midafternoon lull, or rise in likelihood of sleepiness to 3 is followed by another trough of 1 in early evening, rising stepwise towards late night, through midnight and into the early hours of the morning. Accordingly, in view of the above and other problems with the conventional art, it is an object of the present invention to provide an automatic dialog system that is capable of keeping a driver awake during long or evening trips. The system can carry on a conversation with a driver on any one of various topics with the help of a natural dialog car system. In such a system, the driver is obliged to participate in the conversation with the dialog car system. The natural dialog car system often includes humorous content for combating fatigue in the driver.

It is a further object of the present invention to provide a natural dialog car system including a natural language processing module that can understand the content of answers or questions uttered by a driver, and produce meaningful responses. It is a further object of the present invention to provide a natural dialog car system for interpreting a driver's answers and producing machine responses. An even further object of the present invention is to provide a natural dialog car system that understands content of tapes, books and radio programs, and extracts and reproduces appropriate phrases from those materials while it is talking with a driver. For example, a system can find out if someone is singing on a channel of a radio station. The system will state “And now you will hear a wonderful song!” or detect that there is news and state “Do you know what happened now—hear the following—and play some news.” The system also includes a recognition system to detect who is speaking over the radio and alert the driver if the person speaking is one the driver wishes to hear.

According to yet a further object of the present invention, there is provided a natural dialog car system directed to human factor engineering, for example, people using different strategies to talk. For instance, short vs. elaborate responses. In this manner, the individual is guided to talk in a certain way so as to make the system work (e.g., “sorry I didn't get it, could you say it briefly”). Here, the system defines a narrow topic of the user reply (answer or question) via an association of classes of relevant words via decision trees. The system builds a reply sentence asking what are most probable word sequences that could follow the users' reply. According to yet a further object of the present invention, there is provided a natural dialog car system including a conversation planner for keeping the driver alert. An analyzer of the driver's answers and content of the answers and his voice patterns are judged to determine the alertness of the driver while he is driving. This module contains a set of prototypes for different voice patterns corresponding to different levels of a driver's alertness. The system analyzes the quality of the driver's answers, and detects a time that is needed for the driver to answer. The system matches the output parameters (response time and quality of answers, etc.) with a table and determines whether the driver conditions from this and the other set of parameters. The system alerts a driver or changes a topic of conversation and/or sounds an alarm if it finds that he is tired or about to fall asleep. The system may detect whether a driver is effected by drug or alcohol in this manner as well.

### BRIEF DESCRIPTION OF THE DIAGRAM

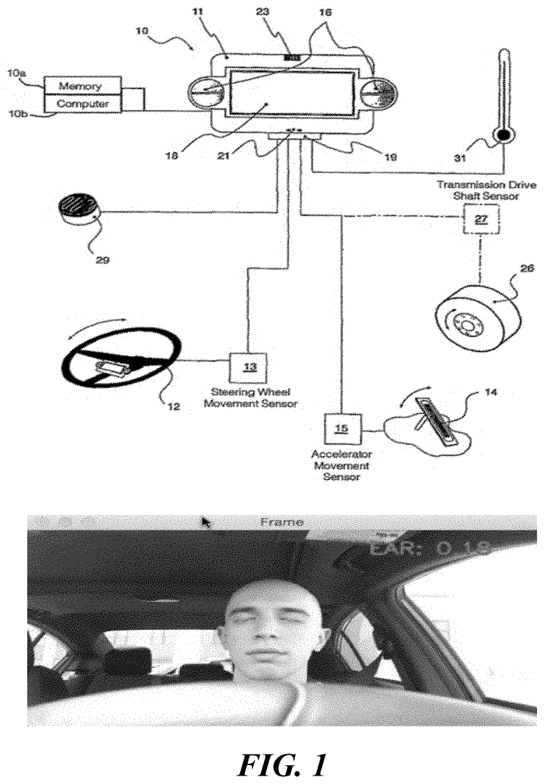

FIG. 1 shows the circuit layout of principal elements in a sleepiness monitor for a road vehicle driver;

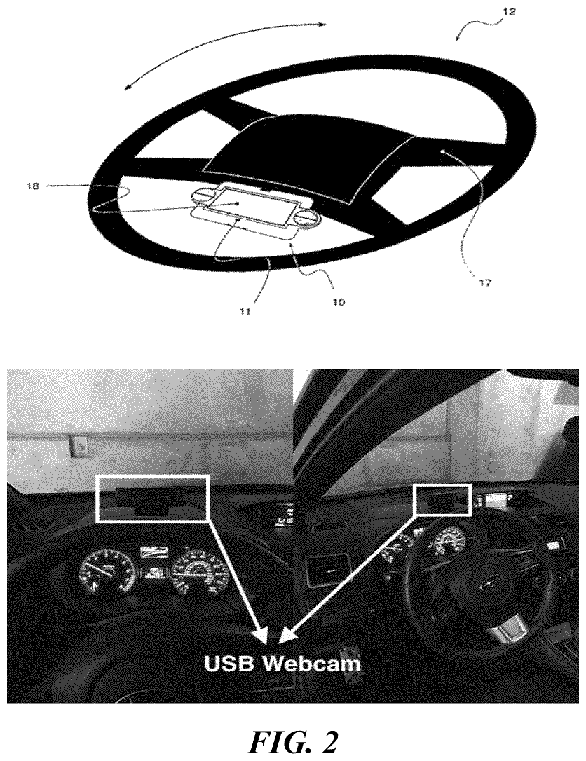

FIG. 2 show an installation variant for the indicator and control unit of the sleepiness monitor shown in FIG. 1;

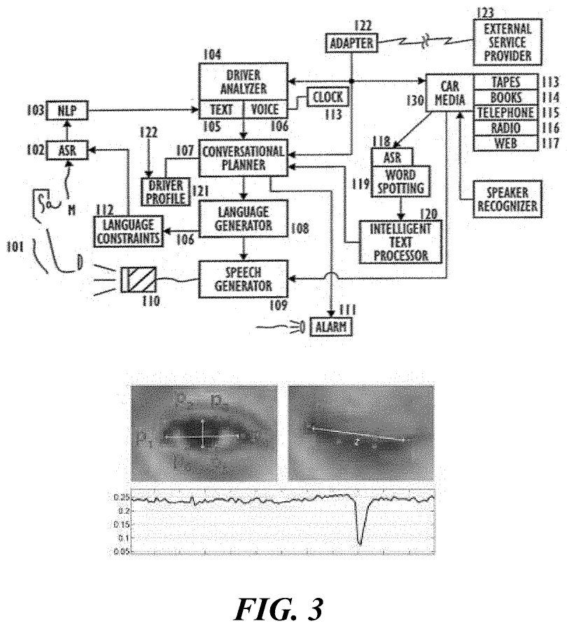

FIG. 3 is a block diagram of an automatic car dialog system according to a preferred embodiment of the present invention.

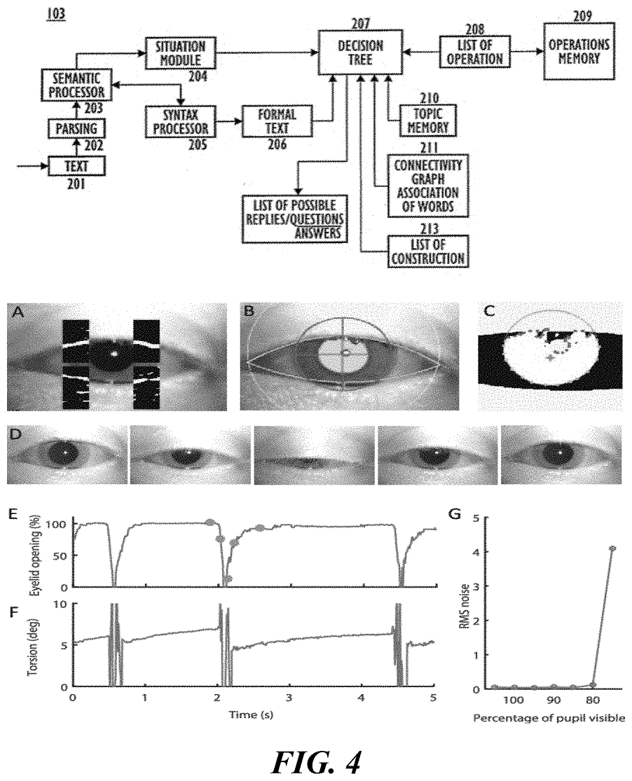

FIG. 4 illustrates a natural language processor module of the system of FIG. 3

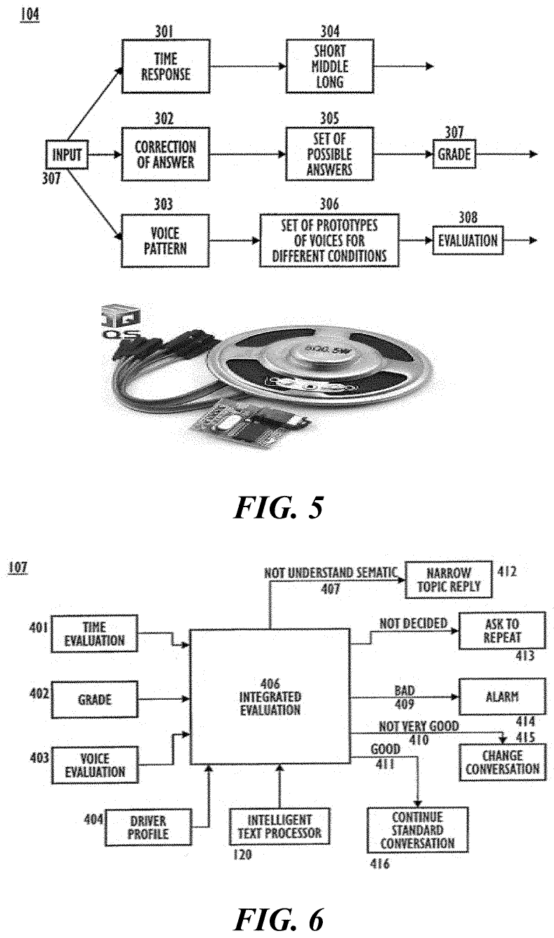

FIG. 5 illustrates a driver analyzer module of the system of FIG. 3

FIG. 6 illustrates a conversational planner module of the system of FIG. 3.

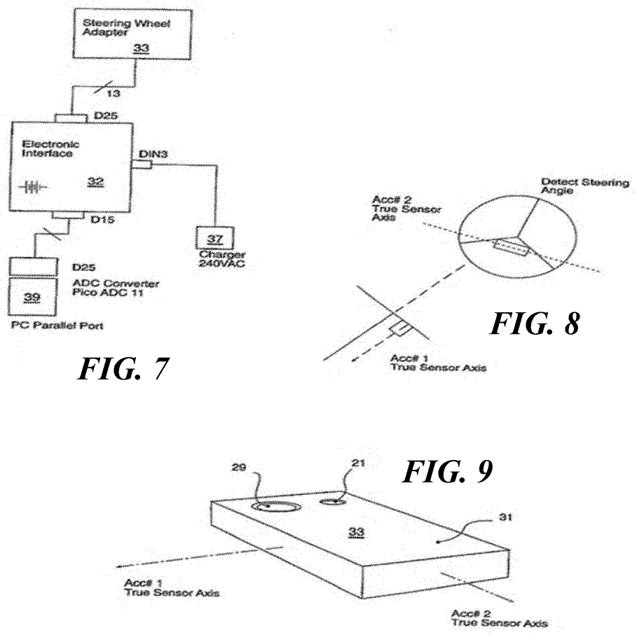

FIG. 7 shows principal elements of a driver monitor system, with an integrated multi-mode sensing module;

FIG. 8 shows a sensing arrangement for motion and steering, in relation to respective reference or datum axes, for the multi-mode sensing module of FIGS. 7 and 9.

FIG. 9 shows the multi-mode sensor of FIG. 7 in more detail;

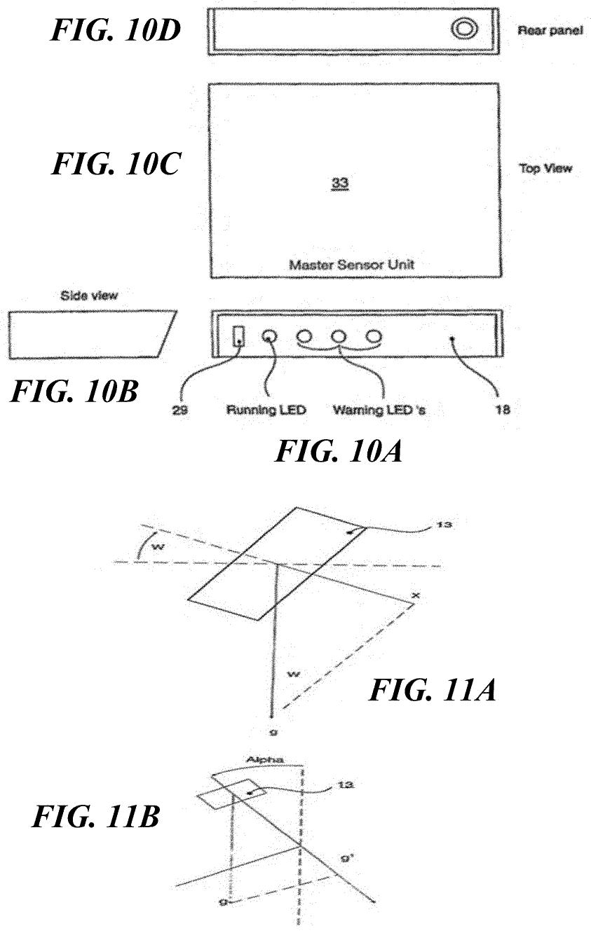

FIGS. 10A through 10D show a variant housing for the multi-mode sensor of FIGS. 7 and 9;

FIGS. 11A and 11B show steering wheel dynamic sensing geometry.

### DESCRIPTION OF THE INVENTION

FIG. 1, a sleepiness monitor 10 is integrated within a housing 11, configured for ease of in-vehicle installation, for example as a dashboard mounting, or, as depicted in FIG. 2, mounted on the steering wheel 12 itself. The monitor 10 may include a memory 10 a and computer 10 b. In a preferred variant, the monitor 10 could be self-contained, with an internal battery power supply and all the necessary sensors fitted internally, to allow the device to be personal to a driver and moved with the driver from one vehicle to another. An interface 19, for example a multi-way proprietary plug-and-socket connector, is provided in the housing, to allow interconnection with an additional external vehicle battery power supply and various sensors monitoring certain vehicle conditions and attendant driver control action. Thus a steering wheel movement sensor 13 monitors steering inputs from a driver (not shown) to steering wheel 12.

The sensor 13 could be located within the steering wheel 12 and column assembly. More sophisticated integrated multi-channel, remote sensing is described later in relation to FIGS. 8 and 9. Similarly, an accelerator movement sensor 15 monitors driver inputs to an accelerator pedal 14. Alternatively, and again in a more sophisticated sensor variant, a dynamic accelerometer could be employed, as in FIGS. 8 and 9.

The sensor 15 could be an accelerometer located within the housing 11 in a self-contained variant. Care is taken to obviate the adverse effects of vehicle vibration upon dynamic sensory measurements. Albeit, somewhat less conveniently, vehicle motion and acceleration could be recognised through a transmission drive shaft sensor 27, coupled to a vehicle road wheel 26 or by interfacing with existing sensors or control processors for other purposes, such as engine and transmission management. The trend to multiplex vehicle electrical supply systems, relaying data between vehicle operational modules, may facilitate such interconnection.

Reverting to the unit 10 of FIGS. 1 and 2, the housing 11 incorporates a visual display panel or screen 18, for relaying instructions and warning indications to the user. A touch-sensitive inter-actional screen could be deployed. Manual or automated adjustment for screen contrast according to ambient light conditions could be embodied. The variants of FIGS. 7, 9 and 10A through 10D allow for a simpler devolved display of certain operating criteria, by multiple LED's on a multi-mode sensor module 33.

A loudspeaker 21 can relay reinforcement sound messages, for an integrated audio-visual driver interaction. Also to that end, in a more sophisticated variant-possibly merely as an ongoing research and development tool, a microphone 23 might be used to record and interpret driver responses, possibly using speech recognition software. Alternatively, interactive driver interrogation and response can be implemented by a series of push button switches 16 arrayed alongside the screen 18, for the input of individual driver responses to preliminary questions displayed upon the screen 18.

Thus, for example, non-contentious factors, such as driver age and sex may be accounted for, together with more subjective review of recent sleep history. Questions would be phrased concisely and unequivocally, for ease and immediacy of comprehension and certainty or authenticity of response. Thus, for example, on the pivotal contributory factor of driver's recent sleep, the question: ‘How much sleep have you had in the last 24 hours’ could be juxtaposed with a multiple choice on screen answer menu, such as:

Choice of ONE answer . . .
Little or none . . . [generating a weighting score of 2]
Less than normal . . . [score 1]
About the same as normal, undisturbed . . . [score 0]
About the same as normal, but disturbed . . . [score 1]
Other contributory factors include road conditions and vehicle cabin temperature.
Road conditions would be assessed through the steering sensor 13, and through an initial input question upon road conditions. Thus, a dull, monotonous road would justify a weighting of plus 1 to all the circadian scores. On the other hand, town driving, promoting greater alertness from external stimuli, would merit a score of minus 1.

Vehicle cabin temperature is taken into account, primarily to register excessively high temperatures which might induce sleepiness. Driver cab temperatures could be monitored with a temperature sensor probe 31 (located away from any heater output vents). Thus, for example, a threshold of some 25 degrees C. might be set, with temperatures in excess of this level triggering a score of plus 0.5. In normal operating mode, the monitor relies upon the working assumption that the driver has had little or no recent or material alcohol consumption. The physiological circadian rhythm ‘template’ or reference model pre-loaded into the monitor memory is adjusted with the weighting scores indicated. If the cumulative score is equal to or greater than 3, the steering sensor is actively engaged and checked to determine the road conditions.

### ALERT

### NEITHER ALERT NOR SLEEPY

### A LITTLE SLEEPY

### NOTICEABLY SLEEPY

### DIFFICULTY IN STAYING AWAKE

### FIGHTING SLEEP

### WILL FALL ASLEEP

An internal memory module may store data from the various remote sensors 13, 15, 27, 29, 31—together with models or algorithms of human body circadian rhythms and weighting factors to be applied to individual sensory inputs. An internal microprocessor is programmed to perform calculations according to driver and sensory inputs and to provide an appropriate (audio-)visual warning indication of sleepiness through the display screen 18. FIG. 2 shows a steering-wheel mounted variant, in which the housing 11 sits between lower radial spokes 17 on the underside of a steering wheel 12—in a prominent viewing position for the driver, but not obstructing the existing instrumentation, in particular speedometer, nor any air bag fitted. Ambient temperature and lighting could also be assessed from this steering wheel vantage point.

FIGS. 10A through 10D show a master sensor unit 33 with a simplified LED warning indicator array. Essentially, the steering sensor measures a change in inductance through an array of some three inductors L1, L2 and L3 through magnetic flux coupling changes caused by movement in relation to the magnetic field of a small magnet ‘M’ static-mounted upon the steering column—at a convenient, unobtrusive location. The inductors L1, L2 and L3 are energized by a 32 kHz square wave generated by a local processor clock.

Induced voltage is rectified, smoothed, sampled and measured by the local processor some 16 times per second. The processor analyses the results digitally to determine the extent of steering wheel movement. Calibration of the minimum and maximum voltages across each inductor as the magnetic field of the static magnet sweeps across them when the steering wheel is fully turned is undertaken by the local processor, so the mounting location of the static magnet is not overtly critical. Such inductive sensing is unaffected by road vibration, since both static magnet and inductors are subject to the same vibration and any effect cancelled out. The local processor feeds sensor data to an executive processor loaded with sleepiness detector algorithms, based upon such factors as circadian rhythm of sleepiness, timing and duration of sleep and ambient light, and which presents an overall indication of driver sleepiness level. The arrangement is capable of registering and measuring very small angular movements, such as might be encountered in corrective steering action at speed

### COMPONENT LIST

10 (sleepiness) monitor
11 housing
12 steering wheel
13 steering position/movement sensor
14 accelerator pedal
15 accelerator position/movement sensor
16 push-button switch
17 steering wheel spokes
18 display panel/screen
19 interface connector
21 loudspeaker
23 microphone
26 road wheel
27 (drive) shaft sensor
29 photocell sensor
31 temperature probe
33 multi-mode sensor
32 electronic interface
37 mains charger
39 parallel data port

Referring to FIG. 3, voice input from a driver 101 is applied to a first automatic speech recognition unit (“ASR”) 102 and to a voice unit module 106 of a driver analyzer module 104 where the characteristics of the driver's voice are measured. The module 104 determines as to whether the driver is alert. A microphone M may be placed near the driver for the driver to speak in to reduce the effect of car noise during the recognition and decoding of speech by the ASR module 102.

The ASR module 102 is known in the art and reference is made in particular to Chin-hui Lee, Frank K. Soong, Kuldip K. Paliwal, “Automatic Speech and Speaker Recognition,” Kluwer Academic Publisher, Boston 1996), which is incorporated herein by reference. The ASR module 102 may be one that is trained for the particular speaker or speaker independent. The ASR module 102 decodes the driver's speech under dynamic language constrains 112, and outputs a decoded signal to a natural language processor (“NLP”) 103. These dynamic language constrains restrict the ASR module process to a predefined topic of conversation, which is defined by a language generator module 108. The module 108 produces machine responses to a driver and in this way defines the context of a driver's reply. This topic can be represented as a set of words that are associated to words generated by the language generator module 108. The associated topic words restrict the decoding of the ASR module 102 to a vocabulary that is composed of these topic related words and other common words. This procedure of decoding under dynamic constrains is similar to what is described in U.S. Pat. No. 5,649,060 to Eloy et al., “Automatic Indexing and Aligning of audio and Text Speech Recognition.” This patent is incorporated herein by reference.

A second ASR module 118 operates with a voice car media 130. The second ASR module 118 decodes, for example, tapes 113, audio books 114, radio programs 116, phone mails 115 and voice content of web sites 117, as well as other audio equipment such as CD player units or DVD player units. The decoding output of the ASR module 118 is analyzed by an intelligent text processor 120 that outputs data to a conversational planner 107. The system builds reply sentences relating to queries of words to the topic under discussion using different techniques known in the art such as: G. Lennart et al. “BORIS—An Experiment In-Depth Understanding of Narratives” Artificial Intelligence Journal 20(1), January 1983, which is incorporated herein by reference, and G. Ferguson et al., “The Design and Implementation of the TRAINS-96 System: A Prototype Mixed-initiative Planning Assistant” TRAINS Technical Note 96-5. The University of Rochester, Computer Science Department, October 1996, which is also incorporated herein by reference.

The system may also include a word spotting module 119 to detect specific words in the car media 130. The specific words are used as spots for speech segments to be played to a driver during the conversation within the car.

Based on the data received from the intelligent text processor 120 and from the driver analyzer module 104, a conversational planner 107 decides whether voice information from the car media 130 should be applied to a speech generator 109 to be played for the driver as part of a response to the present dialog. The NLP module 103, which is described in more detail below with respect to FIG. 4, processes the decoded signal of textual data from the ASR module 102. The NLP module 103 identifies semantic, pragmatic and syntactic content of the message decoded by the ASR module 102, and produces several variants of meaningful responses (questions or answers) and outputs this data as textual data to a text input 105 of the driver analyzer module 104.

The driver analyzer module 104 receives the textual output data from the NLP module 103 and receives voice data from the driver 101, and measures the time of response using a clock 113. An estimation of the quality of the textual responses of the driver (e.g., the ability to answer complex questions), time responses, and conclusions about the driver's artfulness from the driver's voice patterns are generated and output to the conversational planner 107. In other words, the analysis by the driver analyzer module 104 is not only objective (i.e., did the driver respond verbally within a preset time), but also subjective (i.e., did the content of the response make sense). The module 104 is operative to generate complex responses that is used to determine the degree to which the driver is alert.

The conversational planner 107 instructs the language generator 108 as to the kind of response to produce. If the conversational planner finds that the driver continues to be in a perfect or acceptable condition for driving the car, the conversational planner instructs the language generator to continue the conversation in a “natural” manner, i.e., produce the response that is most pertinent to the semantic content of a previous driver's prompt. If, on the other hand, the conversational planner detects that the driver is becoming tired, then the language generator 108 is instructed to change the conversation (i.e., change the topic of conversation). For example, the language generator 108 can produce an unexpected joke (“The stock market fell 500 points! Oh, I am sorry, I was joking.”), or play back real, but unexpected, news clips from the car media unit 130. For example, “there was an earthquake in Los Angeles.” The language generator may also play temperament music. In order to produce a pertinent response, the conversational planner 107 stores information about the driver, such as the driver's tastes, hobbies, age, family, etc. in a driver profile module 121.

In accordance with the present invention, the conversational planner 107 measures a “surprise” element in each of the possible machine replies. This “surprise” measure is different from a probability value defining how likely a hypothesis sequence of words in a possible reply will occur. The “surprise” element in the hypothetical reply is measured as a conditional entropy measure of semantic content in the reply given the driver's prompt. The more unexpected a machine reply, the more additional information is contained in this reply, and the higher conditional entropy measure. The semantic criteria for “surprise” is acting in opposite direction than the probability measure whose objective is to specify the most likely sequence of words given the user prompt. These contra dictionary goals can be considered as a minimum/maximum problem. A set of most probable hypothetical word paths is identified given a driver's prompt that satisfy grammatical, pragmatic and semantic constraints. Then, the least likely phrase is defined in this set from a semantic point of view (given the user prompt).

Other possible methods for naturally generated responses is described in W. Lennart et al. “BORIS—An Experiment In-Depth Understanding of Narratives,” Artificial Intelligence, 120(1) January 1983, pp. 15-62; and G. Ferguson et al., “The Design and Implementation of the TRAINS-96 System: A Prototype Mixed-initiative Planning Assistant” TRAINS Technical Note 96-5, The University of Rochester, Computer Science Department, October 1996, which is also incorporated herein by reference. Both publications are incorporated herein by reference. There are interactions between an analyzer module and a conversation planner, such that if the system suspects that the driver's answers do not satisfy certain predefined criteria relating to the alertness of the driver, the system adjusts the questions to confirm this judgment.

If the conversational planner 107 receives information that suggests the driver is about to fall asleep, it activates an alarm system 111 that is programmable to produce a loud sound or produce some other physical impact on the driver (e.g., a stream of cold air). In determining whether the driver is about to fall asleep, the conversational planner considers other criteria such as: The quality of recognition and decoding by the ASR module 102, and the output of the NLP module 103. The conversational planner 107 may find that the ASR module 102 produced confusable decoding or semantically unclear statements.

For example, the planner 107 can ask the driver to repeat his reply (“Sorry, I did not understand you. Could you repeat what you just told me.”) or try to change the subject conversation to a narrower subject for which it can better identify the topic (“Oh, I just found that there is a PC EXPO on our way. Would you like to attend it?”). While the conversational planner guides the dialog with the driver it constantly analyzes the dynamic content of the car media 130 that is obtained from the intelligent text processor 120. The planner decides whether there is an interesting program from the car media 130 that is pertinent to the topic that is being discussed with the driver and that can be inserted into the dialog. From the driver profile 121, the conversational planner knows that the driver enjoys a certain music artist whose song is presently being played on the radio. In such a case, the conversational planner 107 may interrupt the conversation and state: “Listen, here is your favorite music artist!—let's hear him” and forward the radio program to a speaker 110 via the speech generator 109 that synthesizes text produced by the language generator 108, plays back recorded messages, or transfers the car media data to the speaker 110.

The language generator module 108 chooses the single textual phrase from several candidate phrases produced by the NLP module 103 on the basis of instructions from the conversational planner. Each candidate phrase from the NLP module satisfies different goals and criteria and the final phrase is chosen on the basis of the goal from the conversational planner. The system also includes an external service provider adapter 122 for facilitating communications between the dialog car system and a remotely located external service provider 123. The external service provider 123 may be linked to the dialog car system through any one of various possible ways, such as cellular or other convenient wireless network systems.

The external service provider 123 is coupled through the adapter 122 to the car media module 130, driver analyzer module 104, the driver profile module 121 and conversational planner module 107. Coupled to the driver analyzer module 104, the external service provider receives alert signals if the module 104 finds that a driver is not responding properly to other alerting means (e.g., dialog, sounds and cold air produced by the system). The external service provider is coupled to the car media 130, driver profile 121 and conversational planner module 107 in order to upgrade these modules with new data as it becomes available. The data may be collected from other services that are provided to many dialog systems installed in other automobiles. A monitoring system contained within the external service provider can evaluate the success of various sleep prevention systems and strategies in different cars. For example, if the external service provider determines that some conversational strategies are not as successful in preventing drivers from falling asleep as others, then data can be transmitted to each dialog system in other cars to update the appropriate modules such as the conversational planner 107 such that the less-effective strategies are rarely used or not used at all.

Conversely, if it is found that some strategies are more effective in preventing drivers from falling asleep (e.g., a particular type of conversation prompted an immediate laugh from many drivers) then data is transferred to other dialog systems such that those systems use the more effective strategies. In some instances, the actual content of the conversation will be transferred from the external service provider 123 to the conversational planner 107. For example, if some driver laughed where a random response was produced in a car that mentioned a joke, then that joke will be inserted in other car conversational planner modules 107 and used in those cars. FIG. 4 illustrates the NLP module 103 of the system described above. The module 103 includes a parsing module 202 which receives the decoded output signal of text data 201 from the ASR module 102. The parsing module 202 attaches a parsing structure to the text as described in Jetliner et al., “Decision Tree Parsing Using a Hidden Derivation Model,” Proceedings of the ARPA Workshop on human Language Technology, Princeton, N.J., March 1994, which is incorporated herein by reference. This module 202 parses data to produce grammatically correct and most likely associative responses. Such automatically generated responses generally have a well-defined, sometimes humorous meaning that causes the driver to laugh. Those of ordinary skill in the art will recognize other techniques of parsing data sufficient to fulfill the purposes described herein.

A semantic processor 203 receives an output of the parsing module 202 and interprets the semantic content of each phrase input, using a list of words and associated semantic classes. The processor 203 interprets the syntactic position of the list of words and associated semantic classes in a sentence that is defined by a syntax processor 205. For example, the processor 203 interprets one word received from the syntax processor 205 as a VERB PHRASE and then finds a class of words associated with that given verb. The processor 203 similarly interprets other words which are a NOUN PHRASE or other grammatical PHRASES. A set of associated phrases provides semantic representation of the textual phrase. The semantic representation of the phrase is related to a situation by a situation module 204. The situation module defines a general category where the given semantic content occurs. For example, if the semantic content is relating to a question/answer such as: “I love to drink Coca-Cola?” “We need to stop and buy it”—the situation category can be expressed as “DRINKING”. Similarly, any phrases about love, meetings with girlfriends can be expressed as the situation “SEX”. Phrases about children, wife, husband, mother or father can be expressed as the situation “FAMILY” or the content may be more in-depth, such as FAMILY-MEETING-YEAR-1996 in a given year (e.g., was 1996 a very significant year from the perspective of family life). These situations provide the most general context in which replies by the dialog system will follow the driver's prompts.

The situation categories are related to the list of topics stored in a topic memory 210 via a decision tree module 207. Each situation category is related to a list of topics and events that may happen under the situation category. For example, the “FAMILY” situation defines several topics as family dinners, father going with children to ZOO, etc. The “DRINKING” situation defines events such as someone is thirsty or people are in a bar ordering beer. These events under one situation category are not closely related. For example, two different events under the category “DRINKING” include someone is drinking coffee and someone is dying from thirst in a desert. The dialog system can jump from one event to another event in the same categorical situation. This gives the impression to the driver that his/her phrases and machine responses are situation related and produce humorous impression to the driver if the semantic relationship is weak. For example, the driver may ask the car system: “Do you want to drink coffee?” “The machine system can answer like “I am thirsty like I am in a desert.” The car system has stereotypical phrases for a variety of situations stored in the memory 210.

The decision tree 207 operates with a set of questions (i.e., questions that are semantic, syntactic, pragmatics). The procedure of forming decision trees from questions and splitting a set of properties (semantic, pragmatics, syntactic, etc.) into subsets (i.e., forming questions) is based on a decision tree language module system, which is an extension of a technique described in L. Bahl et al. “A Tree-Based Statistical Language Model for Natural Language Speech Recognition,” IEEE Transactions on Acoustics, Speech and Signal Processing Vol. 37, No. 7, July 1989, which is incorporated herein by reference. The basic difference is that questions in this work were “structural”-like about word relative positions in a sentence. But, according to the present invention, the decision tree is a mixture of all properties of different nature-semantic, grammar, pragmatics and questions may integrate semantic and syntactic information.

Here, the decision tree uses a set of questions concerning different factors such as the driver's interests (hobby, profession, age, etc.) his/her physical conditions, conditions outside of the car (night or day, winter or summer as examples), traffic conditions, and so on. Other sets of questions are related to the driver's replies (for example, “Is the first word a name? Is the second word an action? How long is his phrase? Some questions concern parsing of a phrase, pragmatics and semantics, while some questions are just splits of sets of some properties related to a driver such as answers, conditions, history, etc.)” These questions form a decision tree, which is related to a set of actions and interactions with all modules. These actions can be: ask other question, send a warning signal, play music, activate a radio set, tell news from a radio, produce a joke or other meaningful replies.

The formal text module 206 produces data which is in response to the output by the syntax processor 205 and which consist of formal representation of a sentence (representing logical structure of the sentence and a canonical order e.g., ADJECTIVE NOUN, VERB, etc.) and formal actions between WORDS (e.g., VERB modifies NOUN). These syntactic formal representation is related to the formal semantic representation of each word (e.g., NOUN—WATER, VERB—DRINK and action DRINK(WATER), i.e., a verb acts on a noun. Methods of generating a formal representation of phrases are known in the art. A few methods are described in Gerhard Gazdar and Chris Mellit, “Natural Language Processing in POP-11,” and Addison-Wiley Publishing Company, New York, 1989, both of which are incorporated herein by reference.

A list of operation module 208 contains a list of operations that can be performed with formal sentences from the formal text module 206. The operations are stored in an operations memory 209. The operations include, for example, substitution (e.g., WATER can be replaced by COCA-COLA), recursion (e.g., the phrase HE SAID THAT can be extended as HE SAID THAT HE SAID etc.), and concatenation, (e.g., two phrases can be connected with AND). There are also a set of formal operations that convert questions to a non-question phrase (e.g., “Does he like Coca-Cola?”—“He likes Coca-Cola.”). This list of operations is applied in random order by the decision tree 207 in accordance with predefined decision tree criteria. A connectivity graph module 211 includes words connected with paths if two words are met in the same sentence or have an association of words. See, W. Zadrozny and K. Jensen, “Semantics of Paragraphs,” Computational Linguistics, 17(2): 171-210, 1991.

The associative word graphs are used to associate a set of words given input phrase from the text data 201 after it is formally represented by the decision tree 207. These associated sets of words give rise to a set of associated phrases after formal semantic and syntactic rules are applied to select correct phrases by the list of operation module 208. There is also a list of constructions 213 that represents a full set of possible constructions that involve time or place (e.g., at 5:00, in restaurant etc.) as described in A. E. Goldberg, “Constructions: A Construction Grammar Approach to Argument Structure,” The University of Chicago Press, Chicago, Ill., 1995 (which is incorporated herein by reference). All of this gives rise to a set of possible replies 212 of questions and answers given the driver's input when prompted.

FIG. 5 describes the driver analyzer module 104 as follows. An input data stream 307 (including voice and text data that is time stamped when the driver received a voice prompt from a car system and when he answered) is input to a time response module 301, a correctness of answer module 302, and a voice pattern module 303. The difference in the time (time response) is classified as “short,” “middle,” or “long” by a time evaluator module 304. The answers (textual) are matched with prototypes of possible answers by module 305 and evaluated by a grading module 307 (e.g., very good, good, bad). Voice patterns are matched with a set of voice patterns in a voice pattern module 306, which characterizes various characteristics of voice-pitch, breathing, vagueness, loudness, etc. The sets of prototypes were created from the driver under various known conditions (before going to sleep, in the morning, etc.). In an evaluator module 308, the evaluation is done on the kind of prototypes that best matches the driver's voice condition.

FIG. 6 illustrates the conversational planner module 107. A time evaluation module 401, grading module 402, a voice evaluation module 403 are entered into an integrated evaluation module 406. The time evaluation module 401, grading module 402, and voice evaluation module 403 are similar to the modules 304, 307 and 308, respectively, described above and shown in FIG. 3. The evaluation can be done as weighted sum of evaluations with each criteria.

On the basis of the evaluation different responses are possible. If the module 406 determines that the system did not understand the semantics of the driver's answer it can ask specific questions by outputting a signal on line 407 to the module 412. For example, the module can use the driver profile 404 to ask a question about him that should produce a narrow topic of reply (e.g., “How long have you been married?”). If the module 406 does not understand the answer it can ask the driver via line 408 and module 413 to repeat the answer (“Sorry, please repeat the answer.” or “I did not hear you.”). If the evaluation module 406 detects that the driver is falling asleep it activates an alarm 414 via signal path 409. If the driver's condition is determined to be neither good nor bad, the evaluator 406 outputs a middle signal on line 410 to the change conversation module 415, which then changes the conversation topic. The module 415 uses the information from the intelligent textual processor 120 if it can help change the subject (e.g., tell a breaking news article). If the driver's condition is good then the evaluator 406 outputs a good signal on line 411 to the continue standard conversation module 416 so that the dialog continues in a natural manner.

1. A “car driver alcohol level and sleeping status detection and notification system using machine learning programming and IOT-based technology comprising: a vehicle driver sleepiness monitor, configured as a auto-contained Unit for dashboard unit; wherein an individual driver interrogation and notification response integrated with defined and fixed unit sensory inputs on vehicle condition and driver control action and translates these inputs into weighing factors to adjust a previous history and biological activity circadian rhythm reference Unit, wherein said system includes an in turn to provide a vibration, water spray and audio-visual sleepiness warning alert and an automatic dialog system capable of keeping a drive awake while driving during a long trip or one that extends into the late evening, wherein said system also warns the driver or changes the topic of conversation if the system determines that the driver is about to fall asleep and the system may also detect whether a driver is effected by alcohol or drugs or any other activity, wherein the system includes a for drowsiness detection and accident prevention using Raspberry Pi, wherein the system is an auto rune a real-time system which captures high resolution image continuously and measures the state of the eye movement according to the specified algorithm and gives a warning if required, wherein the system is a closure of the eye exceeds a certain amount which is observed by the camera module connected to the Raspberry Pi or other required device the driver is identified to be sleepy and an alert is given in the form of a buzzer or any other sound from the Pygame module present in the Raspbian OS, wherein the system includes a processor that gradually auto reduces the defined fixed vehicle speed of the vehicle and the system ignition is set to off state by stopping the motor and a GPS module is used to locate the coordinates of the vehicle and a notification is sent to the registered family or friends' numbers.

2. The system according to claim 1, wherein vehicle driver or machine operator sleepiness monitor is configured as a self-contained module for steering wheel or dashboard mounting.

3. The system according to claim 1, wherein said system is used for drowsiness detection and accident prevention using Raspberry Pi, wherein said system is an auto rune a real-time system which captures high resolution image continuously and measures the state of the eye movement according to the specified algorithm and gives a warning if required.

4. The system according to claim 1, wherein if the eye exceeds a certain amount which is observed by the camera module connected to the Raspberry Pi or other required device the driver is identified to be sleepy and an alert is given in the form of a buzzer or any other sound from the Pygame module present in the Raspbian OS.

5. The system according to claim 1, wherein said system provides individual driver/operator interrogation and response, combined with various objective sensory inputs on vehicle condition and driver control action, and translates these inputs into weighing factors to adjust a biological activity circadian rhythm reference model.

6. The system according to claim 1, wherein said system provides an audio-visual sleepiness warning indication and an automatic dialog system capable of keeping a drive awake while driving during a long trip or one that extends into the late evening.

7. The system according to claim 1, wherein said carries on a conversation with the driver on various topics utilizing a natural dialog car system and the system includes an automatic speech recognition module, a speech generation module which includes speech synthesis or recorded speech, and possibly dynamically combined speech synthesizer and recorded speech, and a natural language processing module.

8. The system according to claim 1, wherein said system provides a natural dialog car system analyzes a driver's answer and the contents of the answer together with his voice patterns to determine if he is alert while driving.

9. The system according to claim 1, wherein said system warns the driver or changes the topic of conversation if the system determines that the driver is about to fall asleep and the system may also detect whether a driver is effected by alcohol or drugs.
